(19) United States
(12) Patent Application Publication
(10) Pub. No.: US 2016/0152836 A1
(43) Pub. Date: Jun. 2, 2016

(54) USE OF SILICON-CONTAINING PARTICLES FOR PROTECTION OF INDUSTRIAL MATERIALS FROM UV RADIATION

(71) Applicants: Juergen Erwin Lang, Karlsruhe (DE); Michael Kroell, Linsengericht (DE); Goswin Uehlenbruck, Oberursel (DE)

(72) Inventors: Juergen Erwin Lang, Karlsruhe (DE); Michael Kroell, Linsengericht (DE); Goswin Uehlenbruck, Oberursel (DE)

(73) Assignee: Evonik Degussa GmbH, Essen (DE)

(21) Appl. No.: 14/950,493

(22) Filed: Nov. 24, 2015

(30) Foreign Application Priority Data
Nov. 28, 2014 (EP) 14195301

(51) Int. Cl. C09D 5/03; C08K 3/34; C08K 3/36

(52) U.S. Cl. CPC C09D 5/03; C08K 3/36; C08K 3/34

(57) ABSTRACT

Silicon-containing particles are used for protection of industrial materials, such as electrooptical layers or electrooptical components, from electromagnetic radiation in the UV range and optionally in the visible as far as the IR range, wherein the particles take the form of primary particles having a particle size in the range from 1 to 100 nm and may optionally take the form of clusters of the primary particles. A particular advantage is the possibility of matching the absorption of the electromagnetic radiation to the wavelength region to be absorbed that is of interest in a defined manner via the particle size and the particle size distribution. The silicon-containing particles can be used as biocompatible and biodegradable UV protection in industrial applications and compositions for industrial applications as formulations, such as preferably in coating compositions, such as paint.

### BACKGROUND OF THE INVENTION

1. Field of the Invention

The invention relates to the use of silicon-containing particles for protection of industrial materials, such as electrooptical layers or electrooptical components, from electromagnetic radiation in the UV range and optionally in the visible as far as the IR range, where the particles take the form of primary particles having a particle size in the range from 1 to 100 nm and may optionally take the form of clusters of the primary particles. A particular advantage of the use according to the invention is the possibility of matching the absorption of the electromagnetic radiation to the wavelength region to be absorbed that is of interest in a defined manner via the particle size and the particle size distribution. The silicon-containing particles can be used as biocompatible and biodegradable UV protection in industrial applications and compositions for industrial applications as formulations, such as preferably in coating compositions, such as paint.

2. Discussion of the Background

Silanes, especially silanes of high purity, constitute an important product class in many fields of use, such as the semiconductor industry, construction industry, cosmetics industry or fibre optics industry.

Applications in the field of electronics or optics, or electrooptics, place high demands on the purity of these substances, especially in relation to the optical properties thereof, such as the absorption characteristics in the region of UV radiation, and the optical density (refractive index, n) in the visible spectral region.

In the field of electrooptics and coatings, and here especially in the region of the UV spectral region, a particularly adverse effect is found to be associated with crystal contaminations having the property of having photocatalytic action, for example in the case of TiO₂. Photocatalytic effects of this kind, even in the lower % range, can be extremely troublesome in the coatings applications and greatly limit the lifetime thereof. In addition, materials that are characterized by a high refractive index are of low availability and costly.

There is therefore a need for further UV filters having very good UV protection properties and, at the same time, preferably a high optical density or refractive index. It is assumed to be possible with UV filters of this kind to adjust the profile of properties of electrooptical systems by doping with the UV filters.

### SUMMARY OF THE INVENTION

The problem addressed was therefore that of producing an optically compatible material which firstly features excellent UV protection properties and secondly has a high optical density (expressed in terms of the physical parameter of refractive index), such that it is possible to adjust the profile of properties of electrooptical systems within a wide range in a simple manner via a content of or doping with this material.

The present invention relates to a method for protection of an industrial material, a surface, a component, an electrooptical layer, or an electrooptical component from electromagnetic radiation, the method comprising:
contacting the industrial material, the surface, the component, the electrooptical layer, or the electrooptical component with silicon-containing particles to absorb said electromagnetic radiation;
wherein said electromagnetic radiation has a wavelength range of from 10 to 1500 nm.

The present invention also relates to a biocompatible UV protection composition and/or biodegradable UV protection composition, comprising: silicon-containing particles comprising primary particles of 1 to 100 nm and optionally clusters of said primary particles, having a silicon content of greater than or equal to 90% by weight to 100% by weight.

Moreover, the present invention provides a process for preparing silicon-containing particles, comprising:
a) decomposing at least one gaseous silicon compound or a silicon compound which is gaseous at elevated temperature,
b) optionally in the presence of at least one gas which is reactive under the reaction conditions or of a mixture of reactive gases,
c) in the presence of a diluent gas in an oxygen-free atmosphere under (i) thermal conditions and/or (ii) in the plasma, and
d) depositing silicon-containing particles.

In another embodiment, the present invention provides a UV protection composition, comprising:

amorphous silicon-containing particles comprising primary particles of 1 to 100 nm and optionally clusters of said primary particles, having a silicon content of greater than or equal to 90% by weight to 100% by weight,

or

amorphous silicon-containing particles having a content of greater than or equal to 30% to 100% by weight of silicon and, if the silicon content is less than 100% by weight, the remainder based on 100% by weight of the particles comprises nitrogen, carbon and/or elements of CAS group IIIA or VA, and optionally oxygen,

wherein the median primary particle size is 1 to 500 nm.

### BRIEF DESCRIPTION OF THE DRAWINGS

FIG. 1a shows a TEM image of the silicon-containing particles according to the present invention.

FIG. 1b shows the UV-vis spectra of product 6 (P6) as compared with a typical comparative product TiO2 type P25 (no. 5 in FIG. 1b) from Evonik.

FIG. 2 shows the refractive index of silicon as a function of wavelength ([nm]).

FIG. 3a shows a TEM image of the sample P6 in different enlargement (100 000:1, 200 nm).

FIG. 3b show a TEM image of the sample P6 in different enlargement (600 000:1, 50 nm).

FIG. 4 shows the size distribution of the clusters.

FIG. 5 shows the UV/vis absorption characteristics of a reference sample and of Si of different primary particle sizes and different cluster sizes.

FIG. 6 shows a TEM image of the particles from Example P4.

FIG. 7a shows a TEM image of sample 3.

FIG. 7b shows a TEM image of sample 4.

FIG. 8a shows a TEM image of a dispersion.

FIG. 8b shows a TEM image of a dispersion.

### DETAILED DESCRIPTION OF THE INVENTION

Any ranges mentioned herein below include all values and subvalues between the lowest and highest limits of the range.

Completely surprisingly and unexpectedly, it has now been found that this problem is solved by treating a silane mass flow in an industrial process in an intense infrared field or, in a preferred alternative, in a gas discharge. The silane mass flow, which preferably contains SiH₄, is fed to a plasma discharge arrangement and reacted therein in a high-voltage pulsed discharge, by way of example.

The new approach is to enable the adjustment of the particle size distribution via the specific treatment of the mass flow. Characterization is then effected via the particle size, the cluster parameters of the agglomerates and the particle size distribution. The cluster parameters are calculated preferably by reference to the particle packing density (space filling). For this purpose, the primary particles, in a first approximation, are analyzed as spheres and counted in the unit cell. The cubic space-centered structure known to those skilled in the art contains (1+8·⅛=2) formulae units per unit cell; the cubic face-centered cell contains (6·½+8·⅛=4) formulae units and therefore has the greater packing density. In order to determine the space filling, the procedure is as follows (all spheres are identical in terms of dimensions):

The edge length of the cubic cells is a; the volume of each of the cells is V=a³. In the case of the space-centered structure (SCC), the sphere radius is exactly ¼ of the space diagonal, and in the case of the face-centered structure (FCC) exactly ¼ of the face diagonal. This gives 68% SCC and 74% FCC as the space filling. In the case of a simple cubic cluster, the space filling is less than 50%. From these data, it is possible to determine the absorption as a function of wavelength by means of the antenna aperture known to those skilled in the art as the Hertzian dipole, for example from the lateral dimension. For less symmetric particle geometries, corresponding spatial dependencies then arise. The particle size distribution, as well as the electrophysical properties, directly affects the spectral absorption properties in the UV-vis range of the particle collectives.

According to the invention, the region of the unwanted UV spectrum is damped with simultaneously higher transparency in the visible. This means that particularly the region of short wavelengths from 400 nm to 200 nm is selectively damped with the clusters/aggregates mentioned. In this case, the electrophysical material properties (relative dielectric constant, relative permeability constant) bring about a “shortening of the geometric length of the antenna”, a known concept to those working in the high-frequency field—which leads to active absorption characteristics of geometrically smaller primary particles and clusters thereof, for example in the UV target range. The new approach is to treat the mass flow such that it can be characterized by a particle size distribution which can be used to adjust the spectral absorption properties in the UV range and in the visible range, and optionally in the IR range. With regard to the effect of the gas discharge treatment, the inventors assume that the kinetics are promoted to the effect that non-crystalline silicon, i.e. amorphous silicon, which selectively and preferably silicon particles smaller than 70 nm, with a median particle size of about 25 nm, are formed by plasma chemistry, these exhibiting a high absorption in the UV-A to UV-B, preferably to UV-C, in accordance with the invention (UV-C: 100-280 nm, UV-B: 280 to 315 nm, UV-A: 315 to 380 nm). As a function of the median primary particle size, the absorption in the UV-C and UV-B range can be enhanced compared to the absorption in the UV-A range. In addition, as a function of the median primary particle size, the absorption in the UV-C, UV-B and UV-A range can be enhanced compared to the absorption in the visible range.

In the process according to the invention, the mass flow is amenable to a simple workup, such as filtration, by means of which the pure product is preferentially drawn off. Residual gas obtained, which, as well as monosilane, also contains H_{z}, is subjected to a separation, and monosilane obtained can be recycled. For the known principles of gas discharge and plasma chemistry, reference is made to the relevant specialist literature, for example to A. T. Bell in “Fundamentals of Plasma Chemistry”, ed. J. R. Hollahan and A. T. Bell, Wiley, New York (1974).

The problems are likewise solved in a surprising manner by converting silicon-containing particles by conversion of monosilane or higher H-silanes, such as those of the formula MeHn or Me₂H₂ₙ₋₂, where Me is silicon and n is an integer, halosilanes, higher halosilanes or alkoxysilanes, optionally with C- or N- or Ge-containing species, in a thermal process and/or in a plasma process. Higher H-silanes or chlorosilanes are also referred to as polysilanes or polychlorosilanes. The higher H-silanes or higher chlorosilanes are converted to the gas phase prior to the conversion thereof. The halogen may be selected from fluorine, chlorine, bromine and iodine, and is preferably chlorine.

According to the invention, the problems are likewise solved by the inventive use of silicon-containing particles, especially of amorphous particles, especially of non-crystalline particles containing pure silicon, by using the particles for protection of industrial materials from electromagnetic radiation in the wavelength range from 10 to 2500 nm, especially to 1500 nm. Preferred industrial materials include industrial surfaces or industrial components, more preferably electrooptical layers, electrooptical components, electronic layers, electronic components, industrial glasses, optical glasses, adhesive tapes and further materials and components known to those skilled in the art, etc. According to the invention, the use can be effected in bulk and/or as a surface coating.

The invention thus also provides for the use of the silicon-containing particles for protection, such as UV protection, of industrial materials in bulk and/or by means of a coating from electromagnetic radiation, of industrial materials, surfaces, components, electrooptical layers, electrooptical components, and/or for use as coating.

More particularly, the particles are used for protection from decomposition, damage by UV radiation, or else to increase the optical density of materials.

Particular preference is given to the use of silicon-containing particles that are essentially amorphous particles. Amorphous particles are considered to be those having a crystallinity of less than or equal to 2%.

Preferred particles containing pure silicon, especially primary particles, which are preferably present in clusters, have a silicon content of greater than or equal to 90% by weight to 100% by weight, in relation to the overall composition of silicon-containing particles; more particularly, the silicon content is greater than or equal to 55% by weight, the silicon content preferably being greater than 80% by weight, 95% by weight, 98% by weight, 99% by weight, 99.5% by weight, 99.99% by weight, 99.999% by weight to 100.0% by weight, and the particles are optionally made up to the silicon content of 100 in % by weight by a content of carbon and/or oxygen, the particles preferably being essentially amorphous.

The oxygen content is less than 50% by weight, preferably less than 30% by weight, more preferably less than 10% by weight, depending on the primary particle size. According to the invention, the content is guided by the surface to volume ratio.

Particular preference is given to use of silicon-containing particles which are essentially amorphous and consist of silicon, silicon carbide, silicon nitride (Si₃N₄), SiC—Si, SiGe, SiGe:C or mixtures of these, optionally having an oxygen content, such as Si—O, and a possible dopant, for example selenium, as free-radical scavenger.

The invention likewise provides for the use of the silicon-containing particles for absorption of electromagnetic radiation in the wavelength range of greater than or equal to 10 nm to 1100 nm, especially in the wavelength range from 10 nm to 450 nm. Particular preference is given to using the silicon-containing particles as UV protection, preferably as UV protection in the wavelength range from 180 to 400 nm, more preferably from 200 to 380 or to 400 nm. It is likewise preferable that the silicon-containing particles can also provide protection from electromagnetic radiation in the wavelength range of the extreme UV such as 10 to 100 nm to 120 nm, in the far UV from 200 to 280 nm, in the middle UV from 280 to 315 nm and/or in the near UV from 315 to 380 nm, and, according to the size of the primary particles, from 400 to 750 nm in the visible range and optionally in the IR range above 750 nm to about 1500 nm. The defined absorption in the aforementioned ranges can be set specifically via the content of the respective median primary particle sizes.

In addition, it is possible to preferably use silicon-containing particles having a content of greater than or equal to 40% to 100% by weight of silicon and comprising 60% to 0% by weight of a content of nitrogen, carbon and/or elements of CAS group IIIA or VA, preferably boron, aluminum, phosphorus, arsenic, selenium and/or antimony, and optionally oxygen, where the primary particle size is from 1 to 500 nm, the primary particle size preferably being 1 to 80 nm, further preferably 1 to 70 nm.

It has been found that the spectroscopic properties of the amorphous particles can also be adjusted directly via the production process in terms of the distribution of the primary particle sizes and/or cluster formation, and optionally via an addition of carbon, nitrogen, germanium or further silanes.

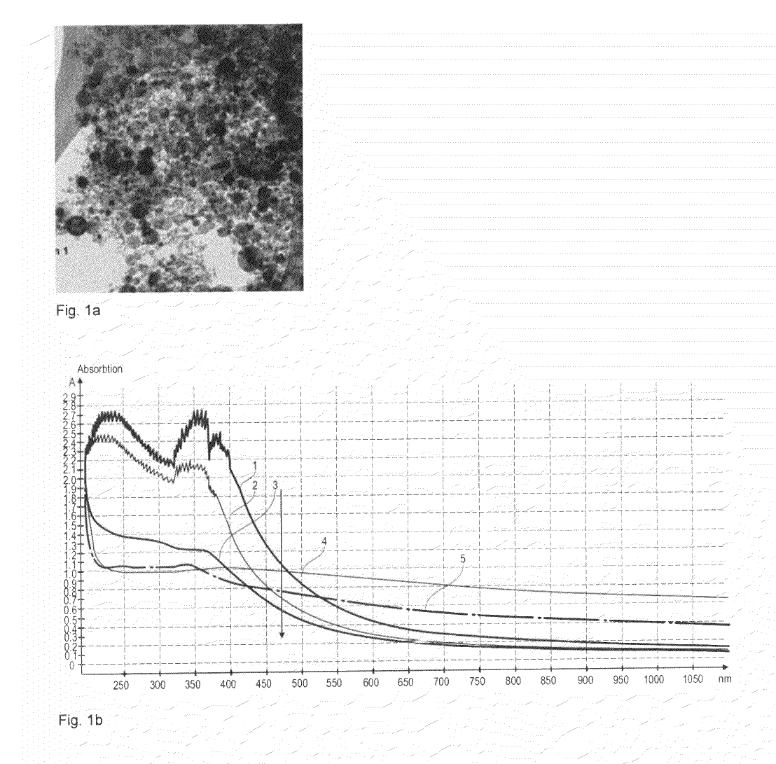

It was thus possible to directly adjust the absorption via the particle size of the silicon-containing particles which comprise primary particles and clusters of primary particles. Surprisingly, particles having a primary particle size of 5 to 80 nm and different median particle sizes d₅₀ around 20, 25, 30, 35 and 40 nm have distinctly different absorption in the UV and visible ranges. Silicon particles having a mean particle size of the primary particles of 25 to 30 nm, especially with d₉₀ of 10 to 50 nm, absorb much more strongly in the UV region than in the visible region, whereas particles having a mean particle size of the primary particles of 35 to 40 nm, especially with d₉₀ of 10 to 70 nm, preferably 10 to 50 nm, absorb with comparable intensity in the UV/vis range (FIG. 1b).

The invention also provides for the use of silicon-containing particles having a particle size selected from: a) median primary particle size d₅₀=1 nm to 200 nm, especially having median primary particles of 5 to 100 nm, and/or b) median primary particle size d₅₀=1 to 10 nm, and/or c) median primary particle size d₅₀=16 to 40 nm, and mixtures comprising a, b and/or c. The optical properties of the mixtures can be adjusted specifically via the content of the respective median primary particle sizes.

Preferably, the amorphous silicon-containing particles have a median primary particle size according to example TEM P6: 20 nm, 25 nm, 30 nm or 40 nm, in each case independently with a low scatter of +/−10 nm, especially +/−5 nm, for d₉₀.

The clusters of the primary particles may be 30 to 400 nm in size, the clusters having typical sizes, for instance, of 150 nm plus/minus 50 nm or alternatively of 50 to 100 nm.

Inventive silicon-containing particles having primary particles having a median primary particle size of 10 to 30 nm, such as preferably around d₅₀=13.2 nm and preferably d₂₀=7.2 nm and d₉₀=23.5 nm, have a transparency of less than 40% (absorption greater than or equal to 0.6) in the wavelength range from 180 to 1000 nm, especially a transparency of less than or equal to 20% (absorption greater than or equal to 0.8) at 180 to 700 nm, and preferably additionally a transparency of less than 5% (absorption greater than 0.95) from 180 to 475 nm, the primary particles preferably forming clusters of mean cluster size greater than or equal to 50 nm and being amorphous.

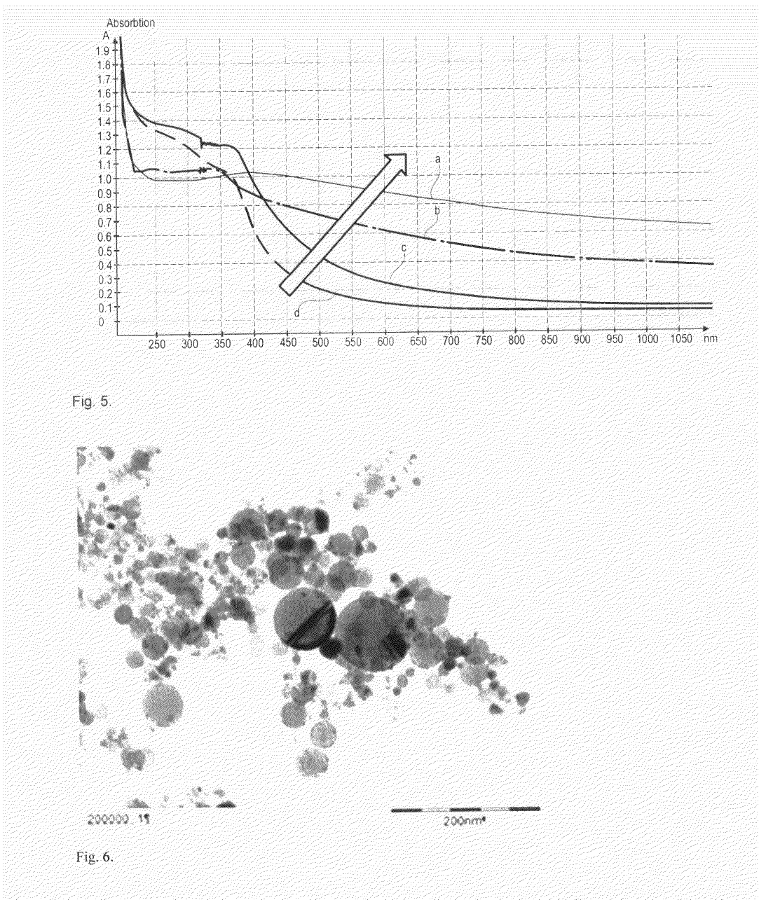

Alternative inventive silicon-containing particles having primary particles having a median primary particle size of 35 to 40 nm have a transparency of less than 40% (absorption greater than or equal to 0.6) in the wavelength range from 180 to 400 nm, especially a transparency of less than or equal to 0% (absorption greater than or equal to 1.0) at 180 to 350 nm, and preferably additionally a transparency of less than or equal to 0% (absorption greater than 1.2) from 180 to 300 nm, the primary particles preferably forming clusters having a mean cluster size of 30 to 400 nm, especially around 150 nm plus/minus 50 nm, and being amorphous. For instance, FIG. 4 shows the size distribution of the clusters, and FIG. 5 the UV/vis absorption characteristics of a reference sample and of Si of different primary particle sizes and different cluster sizes.

The invention likewise provides for the use of silicon-containing particles having 40% to 100% by weight of silicon and made up to 100% by weight by, i.e. with 60% to 0% by weight of, a content of nitrogen, carbon and optionally oxygen. The SiC-containing particles are preferably transparent. In one alternative, the particles include silicon to an extent of 60% to 100% by weight and are made up to 100% by weight by a content of carbon and optionally oxygen. These particles are preferably transparent. More particularly, the silicon particles comprise up to 40 to 50 mol % of silicon and 40 up to 50 mol % of a content of carbon and optionally additionally oxygen. Particular preference is given to SiC particles optionally having a content of less than 10 mol % of Si—O. In a further alternative, the particles include silicon to an extent of 35% to 50% by weight and are made up to 100% by weight, i.e. to an extent of 50% to 65% by weight, by a content of nitrogen and optionally oxygen. Preference is given to silicon nitride particles which are preferably transparent in the visible region in a coating. More particularly, the silicon particles comprise up to 40% by weight of silicon and are made up to 100% by weight by a content of nitrogen and optionally oxygen, particular preference being given to Si₃N₄ particles optionally having a content of Si—O.

Preferably, the silicon content in the overall composition of the silicon-containing particles or in the respective individual particles is greater than or equal to 70% to 99.9999% by weight, especially 80% to 99.9999% by weight, preferably 90% to nearly 100% by weight, more preferably 95% to nearly 100% by weight, more preferably greater than or equal to 98.5% by weight, of silicon, and optionally additionally at least carbon and/or oxygen.

It is likewise possible to use silicon-containing particles consisting essentially of amorphous pure silicon particles or else of amorphous pure silicon carbide, silicon nitride and/or silicon-germanium particles of the aforementioned primary particle size or mixtures of these.

The invention provides a large-scale industrial process, preferably a continuous process, for preparing silicon-containing particles, comprising primary particles and optionally clusters of primary particles.

The reaction, especially comprising the breakdown and formation of the particles and the clusters, can be effected at temperatures of 150° C. upwards, preferably from 400 to 1500° C., for production of amorphous powders. For production of amorphous particles, short contact times, preferably at temperatures below 1300° C., are chosen. Alternatively, the formation of amorphous primary particles can be effected at temperatures around 1300° C., preferably less than or equal to 1100° C. The particles are deposited in a cooler zone of the reactor. Preferred contact times are from 10 to 600 milliseconds.

In the context of the invention, the terms “contact time” and “residence time” are understood to be equivalent.

For instance, customary conventional processes based on a conversion of SiCl4 require 30 kW/kg or more. The processes according to the invention are preferably based on a reaction of monosilane with an energy requirement of less than 10 kW/kg, more preferably around 5 kW/kg. In addition, for the conversion in a (cold) plasma, the energy requirement is reduced further to less than 4 kW/kg.

Particular preference is given to silicon-containing particles in which less than 40% of the particles have a deviation from the median particle size d₅₀ and less than 25% have a deviation of greater than or equal to 50% from the median particle size d₅₀.

Preference is further given to silicon-containing particles wherein the primary particles have a median diameter d₅₀ (determined by TEM evaluation; TEM=transmission electron microscopy) in the range from 5 to 80 nm, preferably from 20 to 50 nm, and which preferably take the form of aggregated clusters. The clusters can also be referred to as agglomerates, a cluster in the present case being understood to mean aggregated or fused primary particles. For instance, the primary particles can form clusters in which at least two primary particles are fused to one another at their surfaces. These clusters may take the form of linear chains or of wires, or else be in branched form in three-dimensional space.

Whether the particles are spherical or take the form of whiskers depends on factors including the H₂ concentration in the preparation. According to the temperature profile, purity (presence of metallic elements, for example selenium (Se) in the gas stream), diluent gas (concentration, flow rate), production conditions, it is possible to isolate primary particles or to obtain predominantly primary particles agglomerated to clusters. For instance, in the case of a dilute process regime, it is possible to isolate predominantly primary particles, and, in the case of high process gas concentration and/or high temperature, for example around 1500° C., in a preferred variant, to isolate fused clusters.

The invention also provides for the use of clusters of the primary particles as protection from electromagnetic radiation. As well as the area of UV-VIS-IR, this includes the adjoining terahertz and the high- and ultra-high-frequency area, and the range of radio waves up to long waves (>100 hertz).

According to a further alternative, the silicon-containing particles preferably comprise primary particles that are essentially spherical. The mean sphericity, defined as the aspect ratio of the diameters at a 90° angle to one another, is preferably less than or equal to 1.6, preferably less than or equal to 1.4 to greater than or equal to 0.9, preferably from 0.95 to 1.2. The aspect ratio close to the spherical form allows an ideal correlation of the UV absorption to the primary particle size and good homogenizability.

In addition, the silicon-containing particles may comprise primary particles and clusters of primary particles; more particularly, the clusters have a size of 10 nm to 3 μm, preferably of 100 nm to 3 μm, further preferably of 1 μm up to 6 μm. Preferred silicon-containing particles comprise silicon (Si) or optionally SiC, SiGe, SiN compounds of greater than or equal to 99.9999% by weight of silicon. Optionally, the SiC, SiGe, SiN compound has a corresponding content of these compound elements. Preferably, the silicon content is greater than or equal to 94.99% by weight, more preferably greater than or equal to 97.999% by weight. Likewise preferred are particles comprising silicon-nitrogen, silicon-carbon and/or silicon-germanium compounds, such as silicon nitride, silicon carbide, silicon carbide in a silicon matrix. The silicon-nitrogen, silicon-germanium, silicon-carbon compounds may also be present in particulate form in a matrix of essentially pure silicon. Preferably, the silicon-containing particles are present essentially without any outer matrix or coating which may also include a passivating oxide layer. In one alternative, the silicon-containing particles are present with a silicon dioxide zone (core-shell) of typically 1 nm. Preferably, or in the ideal case, the zone comprises a monolayer on the surface.

It is particularly preferable in accordance with the invention when the silicon-containing particles are of high purity, especially of ultrahigh purity. The particles are considered to have high purity when silicon having a content greater than or equal to 99.99% by weight is present in the overall composition, preferably with a content of greater than or equal to 99.999% by weight. Ultrahigh-purity silicon-containing particles are considered to be those having a content of greater than or equal to 99.9999% by weight of silicon in the overall composition. In this case, a silicon dioxide core-shell is not an option.

The impurities in the respective reactants and process products are determined by means of sample digestion methods known to those skilled in the art, for example by detection in ICP-MS (analysis for the determination of trace impurities).

In the inventive particles, the primary particles and optionally the clusters, depending on their size, have a content of less than or equal to 2 atom %/cm³ in the overall composition, preferably less than or equal to 2000 ppm of oxygen, preferably less than or equal to 1000 ppm, especially less than 10 ppm. The analysis is effected, in addition to ICP-MS and HP-GD-MS (high-purity glow discharge mass spectroscopy), preferably by means of neutron activation analysis (NAA). NAA is a highly sensitive physical technique in analytical chemistry for qualitative and quantitative trace analysis, in which the sample to be analysed is bombarded with neutrons (or other particles).

In NAA, a sample of only a few mg (or as the case may be a few μg) is exposed to the neutron stream (of a nuclear reactor). The neutrons react with the nuclei of the sample and convert the stable isotopes to radioactive isotopes having a mass number one higher than the mass number of the stable isotope. In this first nuclear process, a prompt y quantum is emitted, the energy of which can be measured and which gives information about the original nucleus. In most studies, however, it is the breakdown of the radioactive nucleus formed that is used for analysis. It subsequently breaks down with its typical half-life, emitting a beta particle and characteristic gamma radiation which is analysed in a gamma spectrometer. In this way, virtually all elements that occur in a sample are detectable quantitatively and qualitatively. The known properties of the atomic nuclei can be used to determine not only the content of elements but even their isotopes. The measurements can be conducted, for example, at the Berlin Neutron Scattering Center.

The content of diluent gases, such as xenon, argon, krypton, or else nitrogen, in the overall composition of the particles is less than 1% atoms/cm³, especially less than or equal to 1000 ppm by weight, 10 ppm by weight, 1 ppb by weight down to the detection limit, for example to 1 ppt by weight.

The detection limits for the determination of xenon (Xe), argon (Ar), krypton (Kr), or else nitrogen, by neutron activation with an irradiation time of 1 hour, at a so-called flux density of thermal neutrons of 10¹⁴ cm⁻² s⁻¹ are about 10⁻⁸ g (Ne, Xe), about 10⁻⁹ g (Kr), about 10⁻¹⁰ g (Ar) and about 10⁻⁵ g for oxygen (O₂). The detection limit, especially for small samples, may thus be less than or equal to 1000 ppm by weight, 10 ppm by weight, 1 ppb by weight or down to the detection limit, for example to 1 ppt by weight.

To produce the particles containing high- or ultrahigh-purity silicon, a high- to ultrahigh-purity silane is used, for which the definition of pure silane to ultrahigh-purity silane of semiconductor quality is used, such as monomeric and/or polymeric monosilane, H-silane and/or chlorosilane, especially of the general formula I, II and III, or a mixture of the comprising, such as ultrahigh-purity tetrachlorosilane, ultrahigh-purity trichlorosilane and/or ultrahigh-purity dichlorosilane, preferably having a silane content of 80% to 99.9999999% by weight, ad 100% by weight optionally polysilanes, and with a total contamination of less than or equal to 100 ppm by weight to 0.001 ppt by weight as high-purity silane, preferably less than 50 ppm by weight to 0.001 ppt by weight as ultrahigh-purity silane, preferably less than or equal to 40 ppm by weight to 0.001 ppt by weight of total contamination with the elements specified hereinafter. Alternatively, rather than a single silane, it is also possible to use a mixture of silanes, provided that it meets the aforementioned profile of requirements on the silane content.

The invention also provides for the use of silicon-containing particles comprising a) primary particles of primary particle size 1 nm to 500 nm; they especially have primary particles of 3 to 100 nm, preferably 5 to 80 nm. These primary particle sizes are preferably obtained via a plasma method. It is additionally preferable when the particles simultaneously have b) a median primary particle size d₅₀=5 nm, 10 nm, 16 nm, 20 nm, 25 nm, 30 nm or 40 nm, especially in each case independently with a low scatter of preferably less than +/−25 nm for d₉₀, in the case of the 40 nm particles, not taking account of the proportion of the primary particles that are preferably present in the form of a cluster.

Alternatively, primary particles have a particle size of 10 to 50 nm, with +/−35 nm at 50 nm, especially +/−25 nm. Primary particles amenable to a free-space reactor process, for example, based on infrared radiation generally have primary particles, preferably clusters of primary particles, having particle sizes of 100 to 350 nm. Preferably, the inventive clusters have a size of 10 nm to 3 μm, especially 100 nm to 3 μm, 150 nm to 400 nm.

It is preferable when greater than or equal to 70% by weight of the primary particles are present as a cluster, preferably greater than 80% by weight, more preferably greater than 85% by weight to 100% by weight, and greater than 90%, 95%, 98%, 99.5% by weight.

According to the primary particle size, the silicon-containing particles have a pale yellow, orange or light brown color and can therefore also be used if required as pigments in coating material products. The particularly surprising property is manifested here, namely that of simultaneous UV protection and wood-like color. By virtue of the pleasant wood-like warm intrinsic color, the silicon-containing particles applied to the wood are not perceived as unappealing and unpleasant, as is the case for the known white UV filters. The inventive particles may also have a BET surface area of greater than or equal to 40 m²/g.

The invention likewise provides for the use of particles having a median primary particle size d₅₀ of 1 to 5 nm and especially a mean cluster size of 50 to 100 nm, which, as shown by Example P4, have an average of twice as high an absorption in the wavelength range from 200 to 400 nm compared to the absorption in the wavelength range from 500 to 750 nm. FIG. 6 shows a TEM image of the particles from Example P4.

According to a particularly preferred embodiment, silicon-containing particles are used which are especially amorphous, where the particles have the following characteristics of electromagnetic radiation absorption:
a) with a primary particle size of 10 to 50 nm, especially with a median particle size d₅₀ around 35 nm, the absorption in the wavelength range from 250 to 400 nm as compared with the absorption in the wavelength range from 400 to 750 nm is equal with a deviation of +/−40%, especially preferably +/−30%, preferably +/−20%, more preferably +/−10%, and/or
b) with a primary particle size of 10 to 50 nm, especially with a median particle size d₅₀ around 25 nm, the ratio of the absorption in the wavelength range from (i) 250 to 400 nm as compared with the absorption at a wavelength of (ii) 550 nm is about (i):(ii)=2:1 to 8:1, especially 2:1 to 6:1, preferably 3:1 to 6:1, with a deviation of +/−40%, preferably +/−30%, preferably +/−20%, more preferably +/−10%, and/or
c) with a primary particle size of 10 to 50 nm, especially with a median particle size d₅₀ around 25 nm, the ratio of the absorption in the wavelength range from (i) 250 to 400 nm as compared with the absorption at a wavelength of (ii) 500 nm is about (i):(ii)=1.5:1 to 8:1, especially 1.8:1 to 5:1, preferably from 2:1 to 4:1, with a deviation of +/−30%, especially preferably +/−20%, more preferably +/−10%, and/or
d) with a primary particle size of 10 to 50 nm, especially with a median particle size d₅₀ around 25 nm, the ratio of the absorption in the wavelength range from (i) 250 to 350 nm as compared with the absorption at a wavelength of (ii) 450 nm is about (i):(ii)=2:1 to 4:1 with a deviation of especially +/−30%, preferably +/−20%, more preferably +/−10%, and/or
e) with a primary particle size of 10 to 50 nm, especially with a median primary particle size d₅₀ around 25 nm, the ratio of the absorption at a wavelength of (i) 250 nm as compared with the absorption at a wavelength of (ii) 450 nm is about (i):(ii)=2:1 to 4:1 with a deviation of especially +/−30%, preferably +/−20%, more preferably +/−10%, and/or
f) with a primary particle size of 10 to 50 nm, especially with a median particle size d₅₀ around 25 nm, the ratio of the absorption at a wavelength of (i) 350 nm as compared with the absorption at a wavelength of (ii) 450 nm is about (i):(ii)=2:1 to 3:1 with a deviation of especially +/−30%, preferably +/−20%, more preferably +1-10%,
g) where the aforementioned values are achieved particularly for pure, high-purity to ultrahigh-purity and essentially amorphous silicon-containing particles having a silicon content of greater than or equal to 98% by weight and optionally a content of carbon and/or oxygen, preference being given to a silicon content of greater than or equal to 99.5% by weight and optionally additionally oxygen ad 100% by weight in the overall composition. The optical properties can be controlled via the contents of the fractions of the respective median primary particle sizes.

The invention likewise provides for the use of silicon-containing particles, especially amorphous and essentially silicon-containing particles of primary particle size from 1 to 100 nm, for increasing the refractive index of a material, such as an electrooptical material, of an electrooptical layer.

The invention likewise provides for the use of silicon-containing particles selected from particles having a content of pure silicon and SiC with silicon 70% to 90% by weight and 10% to 30% by weight of carbon and pure SiC for increasing the refractive index of a formulation or a material.

The invention also provides for the use of silicon-containing particles selected from SiC particles and particles having a content of silicon and carbon with silicon of 70% to 90% by weight and 10% to 30% by weight of carbon, where the particles have a refractive index (n): i) of greater than or equal to 2.5 up to less than or equal to 1000 nm, ii) of greater than or equal to 2.75 up to less than or equal to 500 nm, and/or iii) of greater than or equal to 3.0 up to less than or equal to 230 nm, and/or iv) of greater than or equal to 3.5 up to less than or equal to 50 nm, especially for essentially pure, amorphous silicon carbide particles having a median primary particle size of 1 to 40 nm.

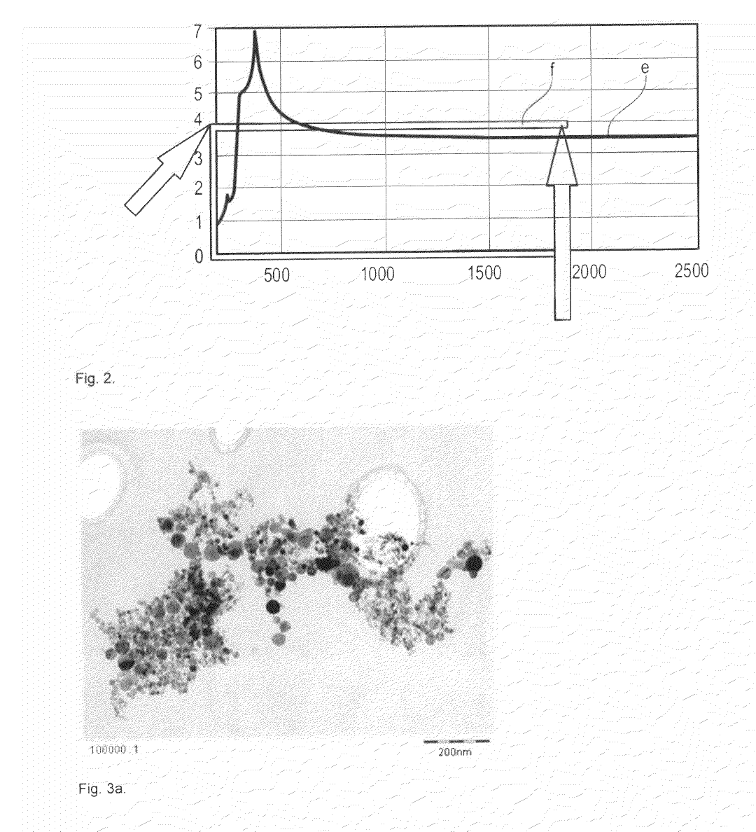

In this case, silicon-containing particles, especially selected from particles having a silicon content greater than 90% to 100% by weight, preferably greater than or equal to 91% to 100% by weight, preferably greater than or equal to 95%, 98%, 99.5%, 99.99% to 100% by weight, have a refractive index (n) of greater than or equal to 3 in the wavelength range from 500 to 2500 nm and/or of greater than or equal to 4.0 at a wavelength of 200 to 500 nm, especially at about 280 to 400 nm. Preferably, the particles, especially pure and amorphous silicon particles, have a refractive index (n) of greater than or equal to 5 to 7 in the wavelength range from about 280 to 400 nm, more preferably of 6 to 7. Preferably, the essentially pure, amorphous silicon particles having a median primary particle size of 20 to 40 nm have these refractive indices, preferably from 250 to 400 nm. The refractive indices thus allow quality control of the purity of the silicon-containing particles produced. FIG. 2 shows the refractive index of silicon as a function of wavelength ([nm]).

The present invention also provides for the use of silicon-containing particles comprising primary particles of 1 to 100 nm and optionally clusters of these primary particles, having a silicon content of greater than or equal to 90% by weight, especially greater than or equal to 95% by weight, to 100% by weight, as biocompatible UV protection and/or biodegradable UV protection. A further advantage of the particles of the invention is the usability thereof as inorganic UV protection, refractive index-increasing material and optionally scratch protection-imparting material.

It is further preferable when the particles have a core-shell having an oxygen content, the particles in this case preferably having a content of Si—O and/or Si—OH or compounds functionalizable with reactive groups in other ways. Particles having a core-shell, which can also be produced in a defined manner in the process, are amenable to a silanization and hence to a further modification and attachment or incorporation into other materials.

In addition, in one alternative, the silicon-containing particles present in the form of primary particles and optionally clusters of the primary particles, and optionally containing silicon carbide, silicon nitride, silicon-germanium, may additionally be doped with an electron acceptor or electron donor. For doping, during the production, at least one gas reactive under the reaction conditions, such as an alloy gas, is added, such as diborane. It is further preferable when the particles can be degraded by cells such as the skin cells or body cells. For instance, the body can preferably convert the amorphous silicon particles gradually to SiO₂ in the aqueous body fluid, and absorb and degrade them. In this case, the particles may be present as essentially spherical particles or else as platelet-shaped particles having a layer thickness of 1 to 80 nm, especially 20 to 45 nm. The particles may be present as platelet-shaped particles when the particles are deposited on a cold surface or particles are introduced into, for example rolled into, a film.

The invention also provides a process for preparing silicon-containing particles, and silicon-containing particles obtainable by this process, by decomposing at least one gaseous silicon compound or one which is gaseous at elevated temperature, b) optionally in the presence of at least one gas which is reactive under the reaction conditions or of a mixture of reactive gases, c) in the presence of a diluent gas in an essentially oxygen-free atmosphere under (i) thermal conditions and/or (ii) in the plasma, and d) depositing silicon-containing particles, especially in the form of amorphous particles comprising silicon having a content of greater than or equal to 30% to 100% by weight of silicon and optionally made up to 100% by weight by a content of nitrogen, carbon, elements of CAS group IIIA or VA, preferably boron, aluminum, phosphorus, arsenic, selenium and/or antimony, and optionally oxygen.

It is preferable here when the silicon-containing particles are deposited with a fluid as amorphous silicon-containing particles. Preferably, the silicon-containing particles are deposited with a gaseous silicon compound, a reactive gas, a diluent gas or a fluid, in the form of a solution, emulsion, suspension, gel, foam, aerosol or smoke. According to the invention, it is preferable to deposit the particles with or in a cooler inert gas.

In the process according to the invention, it is possible to use:
i) gaseous silicon compound or silicon compound which is gaseous at elevated temperature, comprising hydrogen- and/or halogen-containing silanes and/or hydrocarbon-containing silanes such as halosilanes, chlorosilanes such as dichlorosilane, trichlorosilane, tetrachlorosilane, hexachlorodisilane, methyltrichlorosilane, polyhalosilanes, and pure H-silanes such as monosilane, hydrogen-containing polysilanes or polyhalosilanes and/or at least one alkoxysilane, particular preference being given to monosilane, disilane, trisilane and mixtures comprising at least one of the silanes,
ii) as diluent gas argon, helium, xenon, krypton, hydrogen or a mixture of at least two of the gases mentioned, and optionally
iii) as the at least one reactive gas a) nitrogen-containing compounds such as nitrogen, NH₃, alkylamines, germanium-containing compounds, hydrocarbons such as methane, butane and/or propane, and the at least one reactive gas optionally comprises b) alloy gases comprising compounds of the elements of CAS group IIIA or VA, preferably boron, aluminum, phosphorus, arsenic and/or antimony. Under the reaction conditions mentioned, nitrogen is not an inert diluent gas but a reactive gas.

Reactive gases usable with preference also include aromatic compounds such as toluene, especially oxygen-free compounds in each case, with the proviso that no water forms in the decomposition. Preferred reactive gases include hydrocarbons such as methane, ethane, propane, butane, mixtures of these, etc., HCl, hydrocarbons with nitrogen.

The silicon compound may be a gaseous compound such as preferably monosilane or else a compound which is converted to the gas phase at elevated temperature and/or reduced pressure. Useful gaseous silicon compounds generally include all hydrogen-containing silanes such as monosilane, disilane, trisilane and mixtures comprising at least one of the silanes mentioned, and also halogen- and hydrogen-containing or purely halogen-containing silanes and polysilanes, which may also be used in the process in a mixture. Preferably, the silicon compound may include traces of Si—Cl, Si—Br and/or halosilanes, or a Si—Cl-containing compound is added in traces. The silicon compound which is gaseous at elevated temperature may also include hydrocarbon-containing silanes. Preferred silanes are halosilanes, chlorosilanes such as dichlorosilane, trichlorosilane, tetrachlorosilane, hexachlorodisilane, methyltrichlorosilane, polyhalosilanes, and pure H-silanes such as monosilane, hydrogen-containing polysilanes or polyhalosilanes and/or at least one alkoxysilane.

Particularly preferred cooling conditions are elucidated in detail hereinafter. As detailed above, the powders can be formed in two ways, and so the cooling and formation of the silicon-containing particles can be effected by reaction with cool reactive gases, especially liquid nitrogen, optionally having a content of hydrocarbons. The cooling of the breakdown products and the formation of the silicon-containing particles can be effected by introducing the gaseous decomposition products into fluids such as coolants, for example liquid helium, or into a liquid reactive gas. In this case, the silicon-containing particles form directly in the reactive gas. Stabilization can be improved, for example, by using what are called ionic liquids, which are known to those skilled in the art.

Cooling can also be effected by introduction into inert, cool and readily evaporable liquids or by introduction into liquid silicon compounds or boron-containing compounds. Generally, the deposition can be effected by virtue of the fluids for deposition having a temperature well below 1000° C., preferably below 200° C., further preferably below 100° C., more preferably below 50° C. to −273° C. Particular preference is given to rapid deposition by establishing a temperature differential of greater than or equal to 100° C., especially greater than or equal to 200° C., preferably of greater than or equal to 500° C., within one minute, preferably within 1000 milliseconds, below the respective melting point of the silicon-containing particles, more preferably within less than or equal to 100 milliseconds, in order to obtain essentially amorphous particles.

Particularly preferred cooling conditions are elucidated in detail hereinafter. As detailed above, the powders can be formed in two ways, and so the cooling and formation of the silicon-containing particles can be effected by reaction in a cool reactive gas stream, especially cooled with liquid nitrogen, optionally having a content of hydrocarbons. After the silicon-containing particles have been formed, the breakdown products are cooled further by introducing the gaseous decomposition products into fluids, coolants, for example liquid helium, or into a liquid reactive gas. In this case, the reactive gas binds directly to the silicon-containing particle (in the manner of a functionalization).

Cooling of the process gas from the hot non-thermal plasma can also be effected by a suitable process regime, for example by introducing it into inert, cool and readily evaporable media or by introducing it into liquid silicon compounds and/or boron-containing compounds. Generally, the deposition can be effected by virtue of the fluids for deposition having a temperature well below 1000° C., preferably below 200° C., further preferably below 100° C., more preferably below 50° C. to −273° C. Particular preference is given to rapid deposition by establishing a temperature differential of greater than or equal to 100° C., especially greater than or equal to 200° C., preferably of greater than or equal to 500° C., within one minute, preferably within 1000 milliseconds, below the respective melting point of the silicon-containing particles, more preferably within less than or equal to 200 milliseconds, in order to obtain essentially amorphous particles.

Alternatively, the amorphous primary particles can be obtained in a plasma present in a non-thermal equilibrium, the temperatures of which are less than or equal to 1050° C., preferably less than or equal to 700° C., more preferably less than or equal to 150° C. In another variant, the preferred processing is in the low-temperature range, i.e. in the range from 373 Kelvin to greater than 0 Kelvin.

Preferably in accordance with the invention, the plasma comprises the conditions of a gas discharge, especially in a non-thermal plasma.

Non-thermal plasmas used in accordance with the invention are produced, for example, by a gas discharge or by incidence of electromagnetic energy, such as by incidence of radio waves or microwaves, in a reaction chamber. The plasma is thus produced not by high temperatures as in the case of thermal plasmas, but by non-thermal ionization processes. The person skilled in the art is aware of such plasmas. In this regard, what is called the Penning ionization process is cited by way of example.

For the processes detailed above, gas discharges conducted in a non-thermal equilibrium were used. Non-thermal in the sense of the invention means that the electrons as energy-imparting species have a higher temperature and hence a higher energy (kinetic energy) than the heavy particles (N, N₂, N₂⁺, N⁺Si, SiH, SiH₂⁺ . . . C, H, H₂, NH, . . . ). These can be produced by means of power supply units known or familiar to those skilled in the art. The non-thermal plasma generally has electrons having an energy in the range from 0.1 to 100 eV, especially from 1 to 50 eV, and heavy particles having an energy in the range from 0.000 001 to 10 eV, especially 0.01 to 0.1 eV.

It has been found that, surprisingly, such a non-thermal gas discharge can advantageously be produced by dimming (phase gating control) or/and by means of pulsewidth modulation or via the pulse frequency, in which case the electrodes are advantageously designed as hollow electrodes with preferably porous end phases, for example made from sintered metal, by virtue of a two-dimensional parabolic shape. Thus, the gas stream is distributed homogeneously over the electrode surface. The two-dimensional mushroom-like surface can be described by F(r)=r² (0.1<r<1.1 cm). The process according to the invention is generally conducted in non-thermal plasmas having temperatures of 100 to 3400° C., preferably of 700 to 999° C.

The plasma can be pulsed; preferably, an essentially cylindrical plasma, especially non-thermal plasma, is provided in a cylindrical region of the reaction cylinder.

In the syntheses in a plasma, it is appropriately possible to work with an inert gas, for example a noble gas or a mixture of noble gases, for example argon with small proportions of helium, and/or krypton, xenon, and/or reactive gases such as nitrogen, hydrogen, methane, carbon tetrachloride, etc. Other gas mixtures are known to those skilled in the art or can be found in relevant textbooks.

A further preferred embodiment of the process according to the invention includes the introduction of noble gas or of noble gas mixtures or of noble gas/gas mixtures composed of the combination of argon and/or helium, krypton, xenon as diluent gas and optionally reactive gases such as nitrogen, hydrogen, methane, carbon tetrachloride, etc., into the non-thermal plasma especially having temperatures of less than or equal to 3000° C., preferably less than or equal to 1900° C.

A further preferred embodiment of the process according to the invention includes the introduction of noble gas or of noble gas mixtures as diluent gas into the non-thermal plasma especially having temperatures of less than or equal to 1500° C., preferably less than or equal to 1300° C.

In the process according to the invention, it is preferably possible to convert silicon compounds that are gaseous at elevated temperature, comprising hydrogen- and/or halogen-containing silanes, such as H-silanes, halosilanes, and/or hydrocarbon-containing silanes such as methylsilane, methyltrichlorosilane, dimethyldichlorosilane, chlorosilanes, and pure, highly pure and especially ultrapure H-silanes such as monosilane, and/or chlorosilanes such as dichlorosilane, trichlorosilane, tetrachlorosilane, hexachlorodisilane, methyltrichlorosilane, polyhalosilanes, hydrogen-containing polysilanes comprising exclusively hydrogen or hydrogen and halogen. For production of the amorphous particles, it is likewise possible to use alkoxysilanes, preferably tetramethoxysilane, tetraethoxysilane or mixed tetraalkoxysilanes.

Silanes usable in accordance with the invention comprise silanes of the general formula I,

HₓSiCl₄₋ₓ (I),

with x independently selected from 0, 1, 2 or 3, preferably with x=0, 1 or 2, more preferably with x=0 or 1, especially preferably with x=0, or a mixture comprising at least two monomeric chlorosilanes of the formula I, especially selected from tetrachlorosilane, trichlorosilane and dichlorosilane, preferably pure tetrachlorosilane or pure tetrachlorosilane having a content of trichlorosilane and/or dichlorosilane.

It is also possible with preference to use polyperchlorosilane mixtures comprising polyperchlorosilanes having 2 to 8 silicon atoms. Polychlorosilanes up to 6 silicon atoms are readily evaporable, whereas compounds from 7 silicon atoms upwards are processed as aerosol. Particular preference is also given to the use of higher molecular weight polychlorosilanes having at least three silicon atoms, especially having 3 to 8 silicon atoms.

Preference is given to polyperchlorosilane mixtures comprising polyperchlorosilanes having 2 to 100 silicon atoms. Particular preference is also given to the use of higher molecular weight polychlorosilanes having at least three silicon atoms, especially having 3 to 50 silicon atoms, which can be prepared by comproportionation reaction of [SiCl]ₙ, where the [SiCl]ₙ molecule is preferably present as a six-membered ring network with n=6, and multiples thereof. The analysis is effected in the infrared spectral region or by Si²⁹ NMR.

The use of polychlorosilanes according to the invention comprises the homologous series of the polyperchlorosilanes of the general formula II SiₙCl₂ₙ₊₂, with n greater than or equal to 2, which form linear and/or branched chains, and the polyperchlorosilanes which form rings or polymers, where the polymers may be branched and/or cyclic, having the idealized formula III SiₙCl₂ₙ, with n greater than or equal to 3, and also the silicon chlorides having a low chlorine content of the idealized formula IV SiCl_{1.5}. Particularly preferred polychlorosilanes are regarded as being compounds of the general formula II SiₙCl₂ₙ+₂ where n is greater than or equal to 2, especially where n is greater than or equal to 2 to 100, preferably where n is greater than or equal to 2 to 50, preferably in each case independently where n is greater than or equal to 2, 3, 4, 5, 6, 7, 8, 9 or 10, preferably 2 to 8, more preferably where n is equal to 2 or 3, where they may form linear or else branched chains; and compounds of the general formula III which form rings or polymers with SiₙCl₂ₙ where n is greater than or equal to 3, especially where n is greater than or equal to 4 to 100, especially where n is greater than or equal to 4 to 50, more preferably in each case independently where n is greater than or equal to 4, 5, 6, 7, 8, 9 or 10, and also polychlorosilanes having a lower chlorine content according to the general formula IV SiₙCl_{1.5n} where n is greater than or equal to 4 or 5, especially where n is greater than or equal to 6 to 200, preferably where n is greater than or equal to 8 to 100. Particular preference is given to using a polychlorosilane (PCS), especially octachlorotrisilane or an octachlorotrisilane in a mixture with higher molecular weight polychlorosilanes, preferably polyperchlorosilanes, where the polychlorosilane especially has a content of octachlorotrisilane of 20% to 99.9999% by weight, advantageously with an aforementioned contamination profile. It is also possible to use a dissolved polysilane and/or polychlorosilane, for example in a reactive solvent such as hydrocarbon as liquid, syrup, paste, cream, dispersion, emulsion, where the high-purity solvent is evaporated before the decomposition to give a reactive gas. Thus, reactive evaporable solvents are also considered to be reactive gases.

The diluent gas can preferably be mixed with the gaseous silicon compound and/or the reactive gas before being introduced into the reaction cylinder. Alternatively, the inert diluent gas is used for deposition of the particles. The breakdown of the silicon compound and optionally of the reactive gas can also be effected by transfer into a high-vacuum region. A high vacuum is considered to be a vacuum less than or equal to 0.01 bar, especially less than or equal to 0.001 bar, less than or equal to 0.0001 bar.

The pressure range is typically 0.001 mbar to 50 bar, especially 1 mbar to 10 bar, preferably 10 mbar to 5 bar. According to the desired breakdown and/or alloy and/or coating product, and in order to minimize the formation of carbon-containing process gases, the process can also be effected within a pressure range from 1 to 50 bar, preferably at 2 to 50 bar, more preferably at 5 to 50 bar. The person skilled in the art is aware that the pressure to be selected is a compromise between gas removal, agglomeration and reduction of the carbon-containing process gases.

For performance of the process, in addition to the aforementioned features, it is further preferable when the gas discharge is a non-thermal plasma; further preferably, the gas discharge is induced by a generator as also employed in an ozonizer. For a definition of nonthermal plasma, reference is made to the relevant technical literature, for example to “Plasmatechnik: Grundlagen and Anwendungen—Eine Einführung [Plasma Technology: Fundamentals and Applications—An Introduction]; collective of authors, Carl Hanser Verlag, Munich/Vienna; 1984, ISBN 3446-13627-4”.

The specific power input is from 0.001 to 1000 W/cm². More preferably, the specific energy input is from 0.1 to 100 Ws/cm² in the illustrative case with gap widths (GAP) of 1 mm, by way of example. It is further preferable when the specific energy input is conducted by means of exact-phase instantaneous power measurement with a bandwidth of at least 250 kHz. The determination of the instantaneous power is effected in a standardized arrangement with discharge area 50 cm². The energy input for formation of the non-thermal plasma is preferably effected in such a way that very substantially homogeneous conditions develop in the plasma which forms for the conversion of the silanes and of the compounds containing C, N and/or Ge etc.; it is particularly preferable here when the non-thermal plasma is operated at a voltage at which the discharge covers the entire electrode area.

According to a preferred alternative, the deposited particles are organofunctionalized at oxygen atoms and/or chlorine atoms optionally present at the surface. Preferably, the particles are modified at the surface of the particles by reaction with a reactive organofunctional group of the silane. The modification can be effected via complexation or formation of covalent bonds. Generally, the silicon-containing particles can be modified at least partly with an organofunctional silane. Organofunctional silanes include silanes having unsaturated hydrocarbyl radicals, halogen-functionalized silanes such as preferably haloalkylsilanes such as monochlorotrimethylsilane, haloalkoxysilanes such as monochlorotrialkoxysilane, alkylenealkoxysilanes, alkylenehalosilanes, amino-functional silanes such as aminopropyltriethoxysilane, aminopropyltrialkylsilane, and organofunctional silanes. Organofunctional silanes also include organically functionalized silicon compounds and organosiloxanes.

The invention also provides a UV protection composition comprising amorphous silicon-containing particles having a content of greater than or equal to 30% to 100% by weight of silicon and made up to 100% by weight by a content of nitrogen, carbon, elements of CAS group IIIA or VA, preferably boron, aluminum, phosphorus, arsenic and/or antimony, and optionally oxygen, where the median primary particle size is 1 to 500 nm, the particles preferably being present as clusters of primary particles. The composition preferably takes the form of a formulation, especially of a UV protection formulation for industrial applications and/or industrial materials, and comprises at least one auxiliary. The formulation may take the form of a powder, dispersion, suspension, aerosol, embedded in a layer, for example as a film, coating, etc.

A formulation according to the invention preferably comprises at least one auxiliary, additive or further customary formulation constituents.

Since the particles according to the invention are inert, because of their transmission characteristics, they are of particularly good suitability as UV protection compositions, since the particles according to the invention, such as the SiC powders, may be transparent and advantageously do not have any significant transmission around 300 nm+/−80 nm.

An essentially amorphous powder is considered to be one which is x-ray-amorphous. An x-ray-amorphous powder is preferably considered to be a powder having a crystallinity of less than 2%. The crystallinity, which is also called “crystallization level” in the context of the invention, can be ascertained by means of XRPD via the following formula:

(100×A)/(A+B−C)=crystallinity in %

In this formula, A is the total peak area of the reflections of the crystalline constituents in the diffractogram, B is the total area beneath the peak area A, and C is the air scattering-, fluorescence- and instrument-related background area.

Beneath the narrow reflections of the Si phase, the peak area A may have a background. The background area C was ascertained by reference to the XRD diagrams of the Si reference standard NIST 640 (Si standard=100% crystallinity). Area B corresponds to an inserted background profile and the constant background C. Calculation (HighScore Plus Software).

In x-ray-amorphous powders, there are no sharp interferences in the XRPD, but only a few diffuse interferences at low diffraction angles. Substances having an x-ray diffraction diagram of this kind are referred to as x-ray-amorphous. In the case of crystallinity, an anisotropic homogeneous body is present, having a three-dimensionally periodic arrangement of the sub-units and having an XRPD with clearly defined resolvable reflections.

The particle size determination and the formation of clusters such as agglomerates or the presence of primary particles can be determined analytically by the methods which follow. The particle size can be determined by methods including screen analysis, TEM (transmission electron microscopy), SEM (scanning electron microscopy) or light microscopy.

Having generally described this invention, a further understanding can be obtained by reference to certain specific examples which are provided herein for purposes of illustration only, and are not intended to be limiting unless otherwise specified.

### EXAMPLES

### Working Examples

FIG. 1a shows a TEM image of the inventive silicon-containing particles.

FIG. 1b shows the UV-vis spectra of the inventive product 6 (P6) as compared with a typical comparative product TiO2 type P25 (no. 5 in FIG. 1b) from Evonik. Table 1 below discloses, by way of example, the measured absorption (absorption: A, rel. unit) as a function of wavelength (λ [nm]) and as a function of the particle size of samples no. 1 to 5. The arrow points in the direction of increasing median particle size.

TABLE 1
UV/vis to IR spectra (FIG. 1b):

| Spectrum sample no. | | | | | |
|---|---|---|---|---|---|
| 1 | 4 | 3 | 5 | 2 | [λ [nm] |
| 1.7 | 2.4 | 2.6 | 2.6 | 1.6 | 200 |
| 2.7 | 1 | 1.4 | 1.07 | 2.3 | 250 |
| 2.3 | 1 | 1.3 | 1.05 | 2.1 | 300 |
| 2.7 | 1 | 1.25 | 1.05 | 2.1 | 350 |
| 2.3 | 1.03 | 1 | 0.9 | 1.5 | 400 |
| 1.4 | 1.02 | 0.6 | 0.8 | 0.8 | 450 |
| 0.75 | 0.97 | 0.4 | 0.72 | 0.55 | 500 |
| 0.57 | 0.92 | 0.3 | 0.65 | 0.38 | 550 |
| 0.5 | 0.88 | 0.24 | 0.6 | 0.26 | 600 |
| 0.35 | 0.84 | 0.2 | 0.56 | 0.22 | 650 |
| 0.3 | 0.8 | 0.16 | 0.53 | 0.18 | 700 |
| 0.25 | 0.79 | 0.12 | 0.5 | 0.14 | 750 |
| 0.22 | 0.76 | 0.1 | 0.48 | 0.12 | 800 |
| 0.22 | 0.73 | 0.1 | 0.45 | 0.12 | 850 |
| 0.21 | 0.67 | 0.09 | 0.42 | 0.11 | 900 |
| 0.18 | 0.68 | 0.08 | 0.4 | 0.1 | 950 |
| 0.16 | 0.66 | 0.06 | 0.39 | 0.1 | 1000 |
| 0.14 | 0.65 | 0.05 | 0.38 | 0.1 | 1050 |

The spectra 1, 2, 3, 4 and 5 of the samples show a relatively constant absorption for samples 4 and 5 for the wavelength range above 650 nm, while the absorption of the three samples no. 1, 2 and 3 continues to decrease continuously with the smallest median particle sizes.

The assignment of the spectra 1, 2, 3, 4 and 5 of FIG. 1b to the samples is from high to low values:

1: Sample no. 1: Si, d₅₀=5-25 nm (2013048401)

2: Sample no. 2: Si, d₅₀=10-20 nm (20131120)

3: Sample no. 3: Si, d₅₀=20-70 nm

4: Sample no. 4: Si, d₅₀=20-100 nm

5: Sample no. 5: TiO₂-P25

FIG. 2 shows the refractive index of silicon as a function of wavelength (λ [nm]), spectrum e: refractive index of silicon, line f: refractive index n=4.

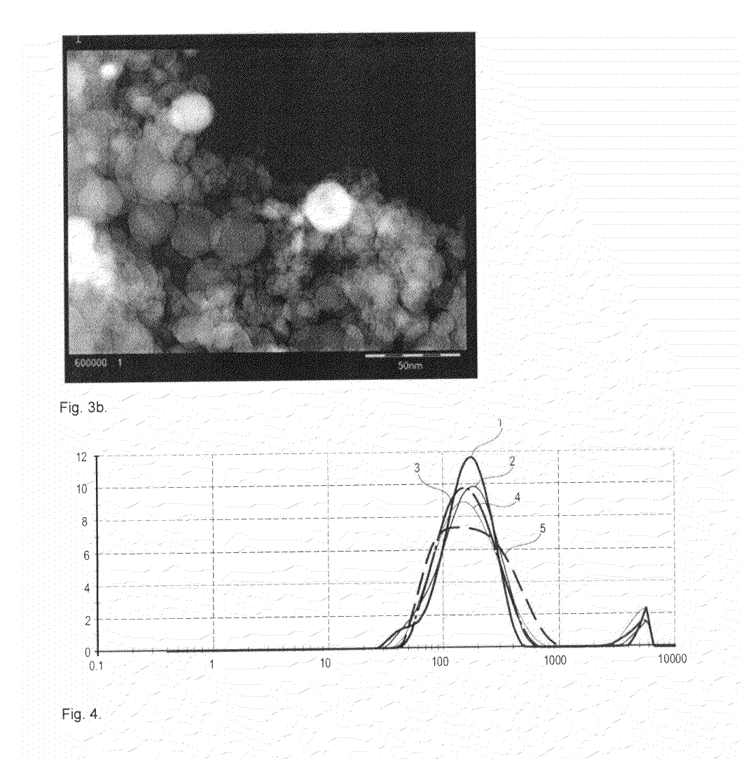

FIGS. 3a and 3b show TEM images of the sample P6 in different enlargement (FIG. 3 (100 000:1, 200 nm) and FIG. 3b (600 000:1, 50 nm).

FIG. 4 shows the size distribution of the clusters. This shows no. 1 (20131007 Si P6 5), no. 2 (20131007 Si P6 3), no. 3 (20131007 Si P6 2), no. 4 (20131007 Si P6 4), no. 5 (20131007 Si P6 1),

FIG. 5 shows the UV-vis absorption characteristics of a reference sample and of Si of different primary particle size and different cluster size. In the direction of the arrow (increasing particle size), the absorption increases with increasing particle size within the wavelength range from above 400 nm to well over 100 nm. Assignment of the spectra in FIG. 5: spectrum d: 20131007-P6/2 mm, spectrum b: TiO₂-P25, spectrum a: 20130912-P4: spectrum 4, spectrum c: 20130912-P3: spectrum 3.

FIG. 6 shows a TEM image of the particles of sample P4.

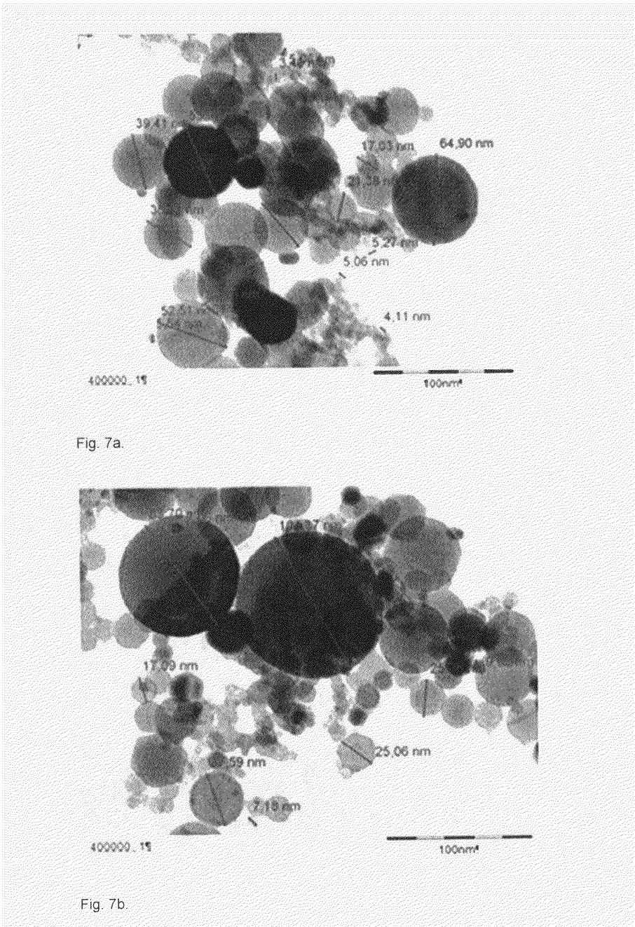

FIG. 7a shows a TEM image of sample 3, which was obtained from a free-space reactor. FIG. 7b shows a TEM image of sample 4. Both samples were amorphous.

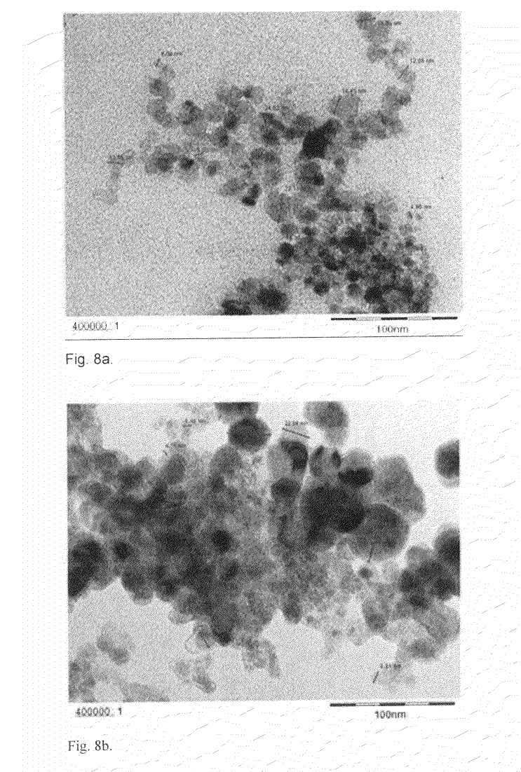

FIG. 8a shows a TEM image of the products of Working Example 2a and FIG. 8b shows a TEM image of the product from Working Example 2b.

All liter figures are in the unit of standard liters. The plasma reactor was operated at 0.4 kW and about 16 kHz with high-voltage pulses having a half-height width of t(50) 500 ns and a mass flow rate of 40 l (STP)/min. For the plasma processes which follow, gas discharges conducted in a non-thermal equilibrium were used.

The free-space reactor used in the examples, abbreviated to “FSR”, had a tangential wall flow. The FSR was equipped with an arrangement for temperature measurement in the reactor. The geometry of a preferred reactor is specified hereinafter. The reactor tube had an external diameter of 36.1 mm and an internal diameter of 33.1 mm. The heating zone was provided for a length of 700 mm at a temperature of 1300° C.

The shielding tube for the temperature measurement probe had an external diameter of 6.7 mm, an internal diameter of 3.7 mm, and a temperature sensor for a measurement of high temperatures up to 2000° C. For a circular gas flow in the FSR, a tangential feed was provided. Table 2 below shows the temperature curve in the reactor at various measurement points.

TABLE 2
Temperature curve as a function of measurement
point (x value in mm) in the tubular reactor

| Measurement | | |
|---|---|---|
| point | X value (mm) | Temperature value |
| M1 | −50 | RT |
| M2 | 0 | 595 |
| M3 | 50 | 926 |
| M4 | 100 | 1078 |
| M5 | 150 | 1149 |
| M6 | 200 | 1199 |
| M7 | 250 | 1227 |
| M8 | 300 | 1239 |
| M9 | 350 | 1238 |
| M10 | 400 | 1222 |
| M11 | 450 | 1186 |
| M12 | 500 | 1120 |
| M13 | 550 | 929 |
| M14 | 600 | 553 |
| M15 | 650 | RT |

### Working Example 1

Obtaining amorphous silicon particles in high-purity form in a free-space reactor. Monosilane is decomposed in an H₂ matrix (60% by volume). The hydrogen is used as heat transferer and as diluent gas. The residence time is from 100 to 500 milliseconds in a tubular reactor having a length of 50 cm.

The cooling and removal of the amorphous silicon is effected in a fluid. In the present case, the decomposition products were passed through liquid paraffin. The amorphous silicon primary particles formed can be stabilized in the paraffin and, according to the production conditions and concentration, are in the form of aggregated primary particles in clusters.

The particles have different primary particle sizes according to the specific process conditions. The process conditions were:

(a) use of a gas mixture of
2 standard liters (l (STP)/min) of argon, 1 l (STP)/min of argon with 5% by weight of SiH₄ for production of samples 3a and 3b.
For sample 3a a residence time of 100 milliseconds was chosen, and for sample 3b a residence time of 500 milliseconds.

(b) use of a gas mixture of
2 l (STP)/min of argon and 2 l (STP)/min of argon with 5% by weight of SiH₄ for production of sample 4.
For sample 4, a residence time of 400 milliseconds in the tubular reactor was chosen.

Sample 3a obtained in (a) had a primary particle size d₅₀ of 20 to 25 nm. For sample 3b, this size was from 50 to 55 nm.

Sample 4 obtained in (b) had a primary particle size d₅₀ of 35 to 40 nm.

The absorption of the amorphous silicon particles of sample 3 having a particle size of about 45 nm which were dispersed in an emulsion in ethanol and had cluster sizes of about 350 nm or less was below 1 in the range from 400 to 1050 nm.

### Working Examples 2a and 2b

### Plasma

(2a) Monosilane was converted in an argon plasma present in a non-thermal equilibrium. The resultant median primary particle size was 5 to 10 nm. The resultant reaction product was dispersed in dilute chloroform. A TEM image of this dispersion is shown in FIG. 8a.

(2b) As experiment (2a), but with extended contact times. Median primary particle sizes of around 30 nm were obtained. The TEM image of the dispersion in dilute chloroform is shown in FIG. 8b.

European patent application EP14195301 filed Nov. 28, 2014, is incorporated herein by reference.

Numerous modifications and variations on the present invention are possible in light of the above teachings. It is therefore to be understood that within the scope of the appended claims, the invention may be practiced otherwise than as specifically described herein.

1. A method for protection of an industrial material, a surface, a component, an electrooptical layer, or an electrooptical component from electromagnetic radiation, the method comprising:
contacting the industrial material, the surface, the component, the electrooptical layer, or the electrooptical component with silicon-containing particles to absorb said electromagnetic radiation;
wherein said electromagnetic radiation has a wavelength range of from 10 to 1500 nm.

2. The method according to claim 1, wherein the particles
a) absorb electromagnetic radiation in the wavelength range of from 10 nm to 450 nm, and/or
b) absorb electromagnetic radiation in the UV range.

3. The method according to claim 1, wherein the silicon-containing particles have a content of greater than or equal to 40% to 100% by weight of silicon and, if the silicon content is less than 100% by weight, the remainder based on 100% by weight of the particles comprises nitrogen, carbon and/or elements of CAS group IIIA or VA, and optionally oxygen, and
wherein the primary particle size of the silicon-containing particles is from 1 to 500 nm.

4. The method according to claim 1, wherein the remainder based on 100% by weight of the particles comprises an element selected from the group consisting of boron, aluminum, phosphorus, arsenic, antimony, and mixtures thereof, and
wherein the primary particle size of the silicon-containing particles is from 1 to 500 nm.

5. The method according to claim 1, wherein the silicon-containing particles are amorphous particles.

6. The method according to claim 1, wherein the silicon-containing particles are amorphous particles of silicon, silicon carbide, silicon nitride (Si₃N₄), SiC—Si, SiGe, SiGe:C or mixtures thereof.

7. The method according to claim 1, wherein the silicon particles have a crystallinity of less than or equal to 2%.

8. The method according to claim 1, wherein the silicon-containing particles have
a) a median primary particle size d₅₀=1 nm to 200 nm,
b) a median primary particle size d₅₀=1 to 10 nm,
c) a median primary particle size d₅₀=5 to 10 nm, and/or
d) a median primary particle size d₅₀=16 to 40 nm or mixtures thereof with fractions of the aforementioned primary particle sizes.

9. The method according to claim 1, wherein the particles comprise 40% to 100% by weight of silicon and, if the silicon content is less than 100% by weight, the remainder based on 100% by weight of the particles comprises nitrogen, carbon and optionally oxygen, and are optionally transparent.

10. The method according to claim 1, wherein the particles having a median primary particle size d₅₀ of 1 to 50 nm and optionally a mean cluster size of 50 to 150 nm, have an average of twice as high an absorption in the wavelength range from 200 to 400 nm compared to the absorption in the wavelength range from 500 to 750 nm.

11. The method according to claim 1, wherein the particles have the following characteristics of electromagnetic radiation absorption:
a) with a primary particle size of 10 to 50 nm, especially with d₅₀ around 35 nm, the absorption in the wavelength range from 250 to 400 nm as compared with the absorption in the wavelength range from 400 to 750 nm is equal with a deviation of +/−40%, and/or
b) with a primary particle size of 10 to 50 nm, especially with d₅₀ around 25 nm, the ratio of the absorption in the wavelength range from (i) 250 to 400 nm as compared with the absorption at a wavelength of (ii) 550 nm is about (i):(ii)=2:1 to 8:1 with a deviation of +/−40%, and/or
c) with a primary particle size of 10 to 50 nm, especially with d₅₀ around 25 nm, the ratio of the absorption in the wavelength range from (i) 250 to 400 nm as compared with the absorption at a wavelength of (ii) 500 nm is about (i):(ii)=1.5:1 to 8:1 with a deviation of +/−30%, and/or
d) with a primary particle size of 10 to 50 nm, especially with d₅₀ around 25 nm, the ratio of the absorption in the wavelength range from (i) 250 to 350 nm as compared with the absorption at a wavelength of (ii) 450 nm is about (i):(ii)=2:1 to 4:1 with a deviation of +/−30%, and/or
e) with a primary particle size of 10 to 50 nm, especially with d₅₀ around 25 nm, the ratio of the absorption at a wavelength of (i) 250 nm as compared with the absorption at a wavelength of (ii) 450 nm is about (i):(ii)=2:1 to 4:1 with a deviation of +/−30%, and/or
f) with a primary particle size of 10 to 50 nm, especially with d₅₀ around 25 nm, the ratio of the absorption at a wavelength of (i) 350 nm as compared with the absorption at a wavelength of (ii) 450 nm is about (i):(ii)=2:1 to 3:1 with a deviation of +/−30%.

12. The method according to claim 1, wherein the silicon-containing particles increase an refractive index of a material compared to the same material having no silicon-containing particles.

13. The method according to claim 1, wherein
a) the silicon-containing particles have a silicon content of 90% to 100% by weight and a refractive index (n) of greater than or equal to 3 in the wavelength range from 500 to 2500 nm and/or greater than or equal to 4.0 at a wavelength of 200 to 500 nm, or
b) the silicon-containing particles are selected from the group consisting of x) SiC particles and y) particles having a content of 70% to 90% by weight of silicon and 10% to 30% by weight of carbon, wherein the particles have a refractive index (n)
i) of greater than or equal to 2.5 up to less than or equal to 1000 nm,
ii) of greater than or equal to 2.75 up to less than or equal to 500 nm,
iii) of greater than or equal to 3.0 up to less than or equal to 230 nm, and/or
iv) of greater than or equal to 3.5 up to less than or equal to 50 nm.

14. The method according to claim 1, wherein the industrial materials are present and are protected from electromagnetic radiation in bulk and/or by a coating.

15. A biocompatible UV protection composition and/or biodegradable UV protection composition, comprising: silicon-containing particles comprising primary particles of 1 to 100 nm and optionally clusters of said primary particles, having a silicon content of greater than or equal to 90% by weight to 100% by weight.

16. A process for preparing silicon-containing particles, comprising:
a) decomposing at least one gaseous silicon compound or a silicon compound which is gaseous at elevated temperature,
b) optionally in the presence of at least one gas which is reactive under the reaction conditions or of a mixture of reactive gases,
c) in the presence of a diluent gas in an oxygen-free atmosphere under (i) thermal conditions and/or (ii) in the plasma, and
d) depositing silicon-containing particles.

17. The process according to claim 16,
wherein
i) gaseous silicon compound or silicon compound which is gaseous at elevated temperature comprises hydrogen- and/or halogen-containing silanes and/or hydrocarbon-containing silanes, hydrogen-containing polysilanes or polyhalosilanes and/or at least one alkoxysilane,
ii) the diluent gas comprises argon, helium, xenon, krypton, hydrogen or a mixture of at least two of the gases mentioned, and optionally
iii) the at least one reactive gas comprises
a) nitrogen-containing compounds, germanium-containing compounds, hydrocarbons and
optionally b) alloy gases comprising compounds of the elements of CAS group IIIA or VA.

18. A UV protection composition, comprising:
amorphous silicon-containing particles comprising primary particles of 1 to 100 nm and optionally clusters of said primary particles, having a silicon content of greater than or equal to 90% by weight to 100% by weight,
or
amorphous silicon-containing particles having a content of greater than or equal to 30% to 100% by weight of silicon and, if the silicon content is less than 100% by weight, the remainder based on 100% by weight of the particles comprises nitrogen, carbon and/or elements of CAS group IIIA or VA, and optionally oxygen,
wherein the median primary particle size is 1 to 500 nm.

19. The composition according to claim 18, in the form of a formulation, which comprises at least one auxiliary.
